(19) United States
(12) Patent Application Publication
(10) Pub. No.: US 2025/0068175 A1
(43) Pub. Date: Feb. 27, 2025

(54) METHOD FOR UPDATING A SCENE REPRESENTATION MODEL

(71) Applicant: Imperial College Innovations Limited, London (GB)

(72) Inventors: Andrew DAVISON, London (GB); Iain HAUGHTON, London (GB); Edward JOHNS, London (GB); Andre MOUTON, Bath (GB); Edgar SUCAR, Oxford (GB)

(21) Appl. No.: 18/941,769

(22) Filed: Nov. 8, 2024

Related U.S. Application Data
(63) Continuation of application No. PCT/GB2023/051469, filed on Jun. 6, 2023.

(30) Foreign Application Priority Data
Jun. 7, 2022 (GB) 2208341.4

(51) Int. Cl. G05D 1/246; G05D 105/80; G06T 7/50; G06T 7/70; G06V 20/70

(52) U.S. Cl. CPC G05D 1/2465; G06T 7/50; G06T 7/70; G06V 20/70; G05D 2105/87; G06T 2207/30244

(57) ABSTRACT

A computer implemented method for updating a scene representation model is disclosed. The method comprises obtaining a scene representation model representing a scene having one or more objects, the scene representation model being configured to predict a value of a physical property of one or more of the objects; obtaining a value of the physical property of at least one of the objects, the obtained value being derived from a physical contact of a robot with the at least one object; and updating the scene representation model based on the obtained value. An apparatus is also disclosed.

### CROSS-REFERENCE TO RELATED APPLICATIONS

This application is a continuation under 35 U.S.C. § 120 of International Application No. PCT/GB2023/051469, filed Jun. 6, 2023 which claims priority to United Kingdom Application No. 2208341.4, filed Jun. 7, 2022, under 35 U.S.C. § 119(a). Each of the above-referenced patent applications is incorporated by reference in its entirety.

### TECHNICAL FIELD

The present invention relates to a method for updating a scene representation model.

### BACKGROUND

In the field of computer vision and robotics, scene representation models can be constructed to represent in virtual space a scene that exists in real space. For example, in order to navigate through a real-world environment or scene, a robot may construct and use an internal scene representation model of that real-world environment or scene. Scene representation models may be generated using simultaneous localisation and mapping (often referred to as ‘SLAM’), where both a representation or mapping of the scene, and a localisation within that scene, may be determined simultaneously.

The paper “iMAP: Implicit Mapping and Positioning in Real-Time” by Edgar Sucar et al, arXiv number arXiv:2103.12352v2, discloses a real-time SLAM system including a scene representation model that predicts geometry and colour of objects of a scene. The scene representation model is optimised by minimising a loss between a captured depth image of the scene and a volumetric rendering of the scene representation model. As such, the optimised scene representation model may represent geometry and colour of objects of a scene.

The paper “iLabel: Interactive Neural Scene Labelling” by Shuaifeng Zhi et al, arXiv number arXiv:2111.14637v2, discloses an extension to the real-time SLAM system in the ‘iMAP’ paper. Specifically, the scene representation model further predicts the semantic class of objects of a scene. A Graphical User Interface is provided to allow a user to provide semantic class labels (e.g. ‘wall’ or ‘book’ etc.) to a captured depth image of the scene. The scene representation model is optimised by minimising a loss between rendered RGB (Red-Green-Blue) values of the scene representation model and real RGB values of the captured image, rendered depth values of the scene representation model and real depth values of the scene from the camera, and the rendered semantic class labels of the scene representation model and the user-provided annotations of semantic class labels. As such, the optimised scene representation model may represent geometry, colour, and user assigned semantic class of objects of the scene.

However, the geometry and colour of an object, and/or a user assigned semantic class (such as ‘book’) of an object, only partially describes the actual nature of the object. Accordingly, known scene representation models are limited in the extent to which they accurately reflect the real-world scene. This may, in turn, place limits on the types of task that can be carried out autonomously by a robot using known scene representation models. Moreover, the user assigned semantic class of an object requires user input, which may place limits on the extent to which an accurate scene representation model can be generated autonomously.

It is desirable to mitigate at least some of these drawbacks.

### SUMMARY

According to a first aspect of the invention, there is provided a computer implemented method for updating a scene representation model, the method comprising: obtaining a scene representation model representing a scene having one or more objects, the scene representation model being configured to predict a value of a physical property of one or more of the objects; obtaining a value of the physical property of at least one of the objects, the obtained value being derived from a physical contact of a robot with the at least one object; and updating the scene representation model based on the obtained value.

This may allow for the scene representation model to include physical properties of objects derived from physical contact of a robot with the objects. For example, this may allow the updated scene representation model to accurately predict physical properties that would be difficult or possible to determine from an image alone. This may, in turn, allow for the updated scene representation model to represent the nature of the objects more completely. This may, in turn, allow the scene representation model to more accurately reflect the real-world scene. Accordingly, an improved scene representation model may be provided for. Alternatively or additionally, this may allow, for example, for a robot operating based on the updated scene representation to carry out a wider range of tasks and/or to do so more accurately. For example, this may allow for a robot to carry out tasks based on the physical properties of the objects of the scene (e.g. to sort boxes having equal geometry and colour but different masses, based on their mass). Alternatively or additionally, the obtained value being derived from physical contact of a robot with the at least one object may allow for an accurate scene representation to be obtained autonomously, for example without necessarily requiring input from a user.

Optionally, the physical contact of the robot with the at least one object of the scene comprises a physical movement of, or an attempt to physically move, the at least one object of the scene by the robot. The obtained value is then derived from the physical movement or the attempt. A robot interacting with a scene can physically move objects (or at least attempt to), and this does not necessarily require special measurement probes. Deriving the value of the physical property based on a movement or an attempt to move may therefore allow for a value of a physical property of an object of the scene (e.g. mass, coefficient of friction, stiffness, or lower bounds on these) to be determined in a cost effective manner.

Optionally, the physical contact may comprise one or more of a top-down poke of the at least one object, a lateral push of the at least one object, and a lift of the at least one object. Different types of physical contact may allow for different physical properties to be determined in a cost-effective manner. In some examples, in each case of a poke, a push or a lift, a distance moved by the robot once contact has occurred may be relatively short, for example on the scale of a few millimetres, which may be sufficient to sample the object's physical attributes but not sufficient to damage or change the location of objects materially in the scene. In other examples, the at least one object may move and/or change location as a result of the physical contact.

Optionally, the value of the physical property is indicative of one or more of a flexibility or stiffness of the at least one object, a coefficient of friction of the at least one object, and a mass of the at least one object. These properties may be determined by movement of the object (or an attempt to move the object) by the robot, and hence need not necessarily involve a special measurement probe to contact the object, which may be cost effective. In one example, the coefficient of friction may be estimated based on a sound made when the robot moves the object.

Optionally, the physical contact of the robot with the at least one object comprises physical contact of a measurement probe of the robot with the at least one object, wherein the obtained value is derived based on an output of the measurement probe when contacting the at least one object. This may allow a wider range of physical properties to be determined, such as a spectral signature, thermal conductivity, material porosity, and material type.

Optionally, the method comprises selecting the at least one object from among a plurality of the one or more objects based on an uncertainty of the predicted value of the physical property of each of the plurality of objects; controlling the robot to physically contact the selected object; and deriving the value of the physical property of the selected object from the physical contact, thereby to obtain the value. This may allow for a robot to select autonomously (e.g. without input from a user) the object to physically contact that may result in the largest decrease in uncertainty in the scene representation model, and hence provide for the largest gain in accuracy and/or reliability of the scene representation model. This may provide for an accurate and/or reliable scene representation model to be autonomously created.

Optionally, selecting the at least one object comprises: determining a kinematic cost and/or feasibility of the physical contact of the robot with each of the plurality of objects; and the at least one object is selected based additionally on the determined kinematic feasibility for each of the plurality of objects. This may allow for a robot to avoid or reduce attempts to obtain values for objects that it would not be able to contact or which would be kinematically costly to contact. This may allow for the scene representation model to be updated in an efficient way.

Optionally, the method comprises: responsive to a determination that the physical contact of the robot with a given one of the plurality of objects is not kinematically feasible, adding the given object to a selection mask to prevent the given object from being selected in a further selection of an object of which to obtain a value of the physical property. This may allow that the kinematic cost and/or feasibility need not be determined multiple times over multiple object selections for objects for which physical contact is not kinematically feasible. This may further improve the efficiency with which the scene representation model is updated.

Optionally, the scene representation model provides an implicit scene representation of the scene. For example, the implicit scene representation may represent the scene implicitly by providing a mapping function between spatial coordinates and scene properties. This may allow for the scene to be represented (and properties thereof to be queried) in a resource efficient manner. For example, this may be as compared to explicit scene representations such as point clouds or meshes of the scene, which can require relatively large resource usage to store, maintain, and interact with. The scene representation model providing an implicit scene representation may, in turn, increase the speed at which the scene representation model may be learned, adapted, and/or interrogated. This may, in turn, help allow for real-time applications of the method.

Optionally, the scene representation model comprises a multi-layer perceptron having a semantic head, wherein for a coordinate of the scene representation input to the multi-layer perceptron, the semantic head outputs the prediction of the value of the physical property at that coordinate. This implementation may provide a particularly resource efficient way to provide a prediction of a value of a physical property of a an object. This may, in turn, help allow for real-time applications of the method.

Optionally, the multi-layer perceptron further has a volume density head and/or a photometric head, wherein for the coordinate of the scene representation input into the multi-layer perceptron, the volume density head outputs a prediction of the volume density at that coordinate and/or the photometric head outputs a prediction of a photometric value at that coordinate. This may provide that the scene representation model also predicts photometric values (e.g. colour, brightness) and geometry (e.g. shape) in a resource efficient manner, which may help allow for use of the method in real-time application, such as real-time SLAM. Alternatively or additionally, the semantic head and the volume density and/or photometric head sharing the same multi-layer perceptron backbone may provide that the improved prediction of a physical property value obtained for one portion of the scene (e.g. one part of an object) may be automatically propagated to other similar portions (e.g. other parts of the same object). This may improve the efficiency with which the scene representation model is updated.

Optionally, updating the scene representation model comprises: optimising the scene representation model so as to minimise a loss between the obtained value and the predicted value of the physical property of the at least one object. This may provide that the physical property value predictions for all of the objects of the scene representation model are updated based on the obtained value. This may provide for a more complete scene representation to be provided for a given number of obtained values, and/or for the scene representation to be updated efficiently.

Optionally, the obtained value and the predicted value each represent one of a plurality of discrete values, and optimising the scene representation model comprises minimising a cross-entropy loss between the predicted value and the measured value; or the obtained value and the predicted value each represent one of a continuum of values, and optimising the scene representation model comprises minimising a mean-squared error loss between the predicted value and the measured value. This may allow for the scene model to be updated where the value is a discrete value (e.g. a category) or a continuous value (e.g. a stiffness).

Optionally, updating the scene representation comprises: labelling a part of a captured image of the scene with the obtained value for the object that the part represents; obtaining a virtual image of the scene rendered from the scene representation model, one or more parts of the virtual image being labelled with the respective predicted value for the respective object that the respective part represents; determining a loss between the obtained value of the labelled part of the captured image and the predicted value of a corresponding part of the virtual image; and optimising the scene representation model so as to minimise the loss. This may provide that the scene representation model may be updated efficiently. This may provide that the entire scene representation can be updated based on one (or more) captured (and labelled) images of the scene. This may, in turn, provide an efficient way to update the model.

Optionally, one or more parts of the captured image are each labelled with an obtained depth value indicative of a depth, of a portion of the scene that the part represents, from a camera that captured the image; one or more parts of the virtual image are each labelled with a predicted depth value indicative of a depth, of a portion of the scene representation that the part represents, from a virtual camera at which the virtual image is rendered; and updating the scene representation model comprises: determining a geometric loss between the obtained depth value of the one or more parts of the captured image and the predicted depth value of one or more corresponding parts of the virtual image; and optimising the scene representation model so as to minimise the geometric loss. This may allow that both the physical property values and the geometry of the scene representation can be jointly optimised based on one (or more) captured images. This may provide an efficient means by which to update the scene representation model. Alternatively or additionally, this may help provide that an obtained physical property value propagates to other portions of the same object and/or to similar objects.

Optionally, one or more parts of the captured image are each labelled with an obtained photometric value indicative of a photometric property, of a portion of the scene that the part represents, at a camera that captured the image; one or more parts of the virtual image are each labelled with a predicted photometric value indicative of a predicted photometric property, of a portion of the scene representation that the part represents, at a virtual camera at which the virtual image is rendered; and wherein updating the scene representation model comprises: determining a photometric loss between the obtained photometric value of the one or more parts of the captured image and the predicted photometric value of one or more corresponding parts of the virtual image; and optimising the scene representation model so as to minimise the photometric loss. This may allow that the physical property values and the photometric values (e.g. colours, illumination) (and also the geometry) of the scene representation can be jointly optimised based on one (or more) captured images. This may provide an efficient means by which to update the scene representation model. Alternatively or additionally, this may help provide that an obtained physical property value propagates to other portions of the same object and/or to other similar objects.

Optionally, the one or more parts of the captured image are sampled from the captured image and the predicted depth value and/or the predicted photometric value are predicted, based on an output from the scene representation model, for a corresponding sample of one or more parts of the virtual image. Accordingly, the updating need not necessarily be based on the entire captured image, but rather samples thereof. This may help increase the speed at which the scene representation model can be updated. This may, in turn, allow for real-time applications of the method, such as in real-time SLAM.

Optionally, the method comprises: estimating a pose of a camera that captured the image when the captured image was captured; and wherein the virtual image is rendered at a virtual camera having the estimated pose. This may provide that the camera capturing the image need not necessarily have a fixed position and/or orientation but can be moved. This may provide for flexibility in the deployment of the method.

Optionally, the pose of the camera is estimated based at least in part on data indicative of a configuration of a device used to position the camera. This may help allow for an efficient estimation of the camera pose for example in cases where the camera is attached to a robotic arm whose base is fixed and whose joint configuration is known (and from which the camera pose can be derived).

Optionally, the pose of the camera is estimated based at least in part on an output of a pose estimation module configured to estimate the pose of the camera, wherein optimising the scene representation model comprises jointly optimising the pose estimation module and scene representation model to minimise the loss. This may help allow for the camera pose to be estimated even where the camera is freely moveable (e.g. by a human user or by a robot). Alternatively or additionally, this may help the camera pose estimate to be fine-tuned from an initial estimate (e.g. based on the joint configuration of a robotic arm).

Optionally, the obtained scene representation model has been pre-trained by optimising the scene representation model so as to minimise a loss between a provided estimate of a value of the physical property of at least one object of the scene and the predicted value of the physical property of the at least one object. This may help provide a relatively accurate scene representation relatively quickly, for example as compared to starting with no information about the physical property value of any of the portions of the scene. These estimates may be based, for example, on typical ranges of stiffnesses of household objects, for example.

Optionally, the estimate is provided by applying a pre-trained object detector to a captured image to identify the at least one object, and inferring the estimate from the identity of the at least one object. This may provide more accurate initial estimates of the physical properties. This may in turn reduce the time (and interactions) taken to generate a relatively accurate scene representation model. For example, object recognition may be first applied to the captured image to identify a portion as a chair, and the estimate of the physical property value may be the typical mass of a chair.

Optionally, the method comprises: controlling the robot (or another robotic device) to carry out a task based on the updated scene representation model. This may allow for the robot to complete a wider range of tasks and/or to do so more accurately, for example as compared to if the model was not updated. For example, this may allow for a robot to carry out tasks defined based on physical properties of objects of the scene, for example to sort boxes having equal appearance but different masses, based on their mass.

According to a second aspect of the invention, there is provided an apparatus configured to perform the method according to the first aspect. In some examples, the apparatus may be a robot, for example the robot of the first aspect. In some examples, the apparatus may comprise a computer configured to perform the method. For example, the computer may be a remote server, for example that is remote from the robot.

According to a third aspect of the present invention, there is provided a computer program comprising a set of instructions which, when executed by a computer, cause the computer to perform the method according to the first aspect. In some examples, the computer may be part of the robot. In some examples, the computer may be part of a remote server that is remote from the robot but is communicatively connected to the robot, for example via wired or wireless means. The computer may comprise a processor and a memory, the memory storing instructions which when executed by the processor cause the processor to perform the method according to the first aspect. According to a fourth aspect of the invention, there is provided a non-transitory computer readable medium having instructions stored thereon which, when executed by a computer, cause the computer to perform the method of the first aspect.

Further features will become apparent from the following description, which is made with reference to the accompanying drawings.

### BRIEF DESCRIPTION OF THE DRAWINGS

FIG. 1 is a flow chart illustrating a method according to an example;

FIG. 2 is a schematic diagram illustrating a scene in real space, according to an example;

FIG. 3 is a schematic diagram of a representation of the scene in virtual space, according to an example;

FIG. 4 is a block diagram illustrating a scene representation model, according to an example;

FIG. 5 is a block diagram illustrating a flow between functional blocks, according to an example; and

FIG. 6 is a block diagram illustrating an apparatus according to an example.

### DETAILED DESCRIPTION

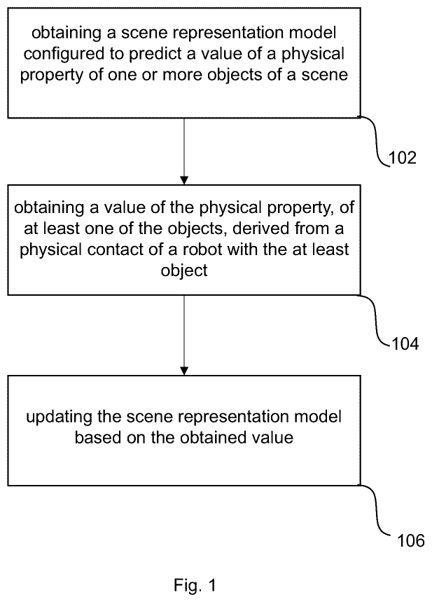

Referring to FIG. 1, there is illustrated a computer implemented method for updating a scene representation model. In broad overview, the method comprises:
in step 102, obtaining a scene representation model representing a scene having one or more objects, the scene representation model being configured to predict a value of a physical property of one or more of the objects;
in step 104, obtaining a value of the physical property of at least one of the objects, the obtained value being derived from a physical contact of a robot with the at least one object; and
in step 106, updating the scene representation model based on the obtained value.

This may allow for the scene representation model to include physical properties of objects derived from physical contact of a robot with the objects. For example, this may allow the updated scene representation model to accurately predict physical properties that would be difficult or not possible to determine from an image alone. This may, in turn, allow for the updated scene representation model to represent the nature of the objects more completely. This may, in turn, allow the scene representation model to more accurately reflect the real-world scene. Accordingly, an improved scene representation model may be provided for. Alternatively or additionally, this may allow, for example, for a robot operating based on the updated scene representation to carry out a wider range of tasks and/or to do so more accurately. For example, this may allow for a robot to carry out tasks based on the physical properties of the objects of the scene (e.g. to sort boxes having equal geometry and colour but different masses, based on their mass).

As mentioned, step 102 comprises obtaining a scene representation model representing a scene having one or more objects.

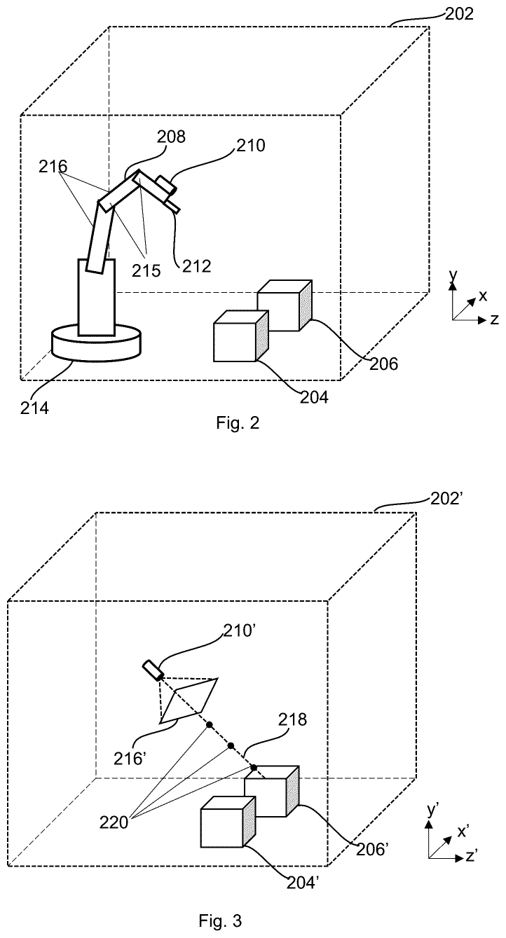

Referring to FIG. 2, there is illustrated a scene 202 having one or more objects 204, 206, according to an example. The scene 202 is in real space (that is, the scene 202 is a real-world scene). Positions within the scene 202 are defined by coordinates x, y, z. In this example, the scene 202 has two objects 204, 206. In this example, each object 204, 206 is a box, and the boxes have the same appearance and geometry. The scene 202 is a real world-environment for a robot 208. In this example, the robot 208 has a camera 210 and a measurement probe 212. In this example, both the camera 210 and the measurement probe 212 are moveable in the scene/environment 202. Specifically, in this example, the robot 208 takes the form of a robotic arm 208. The robotic arm 208 comprises a base 214 and several moveable sections 216 connected by joints 215. The camera 210 and the measurement probe 212 are located on a terminal section of the arm 208. The joints 215 of the robotic arm 208 may be configurable to position the camera 210 and/or the measurement probe 212 at any particular location and with any particular orientation within the scene 202. In the example of FIG. 2, the joints 215 are configured so that the camera 210 is pointing towards the objects 204, 206. In this example, the objects 204, 206 are moveable objects, but it will be appreciated that in some examples the objects of the represented scene may be any objects, for example including immoveable or practically immoveable objects such as a wall of floor of a room.

The obtained scene representation model represents the scene 202. In some examples, the obtained scene representation model may provide an explicit representation of the scene 202 (such as with a point cloud or a mesh or the like). However, in other examples, the obtained scene representation model may provide an implicit representation of the scene. For example, the obtained scene representation model may provide a mapping function between spatial coordinates and scene properties (such as volume density and colour). An explicit representation of the scene 202 in virtual space may be constructed from an implicit representation, if desired, for example by determining the scene properties output from the implicit representation for each coordinate of the virtual space. In any case, the obtained scene representation model represents the scene 202.

Referring to FIG. 3, there is illustrated a scene representation 202′ of the scene 202 of FIG. 2. For ease of visualisation, the scene representation 202′ in FIG. 3 is explicit, but it will be appreciated that in some examples the obtained scene representation model may provide an implicit scene representation, as described above. The scene representation 202′ is in virtual space. Positions within the scene representation 202′ are defined by virtual coordinates x′, y′, z′. The virtual coordinates x′, y′, z′ can be converted into real-world coordinates x, y, z, and vice versa, by suitable coordinate transformation. The scene representation 202′ includes object representations 204′, 206′ which represent the objects 204, 206 of the scene 202. The scene representation 202′ also includes a camera representation 210′, which represents the position and orientation (hereinafter ‘pose’) of the camera 210 in real space.

As mentioned, the scene representation model is configured to predict a value of a physical property of one or more of the objects 204, 206. For example, the scene representation model may be configured to output a prediction of a physical property (such as mass, stiffness etc) of each object 204′ 206′. For example, the scene representation model may be configured to determine, for each coordinate x′, y′, z′ of the virtual space, a prediction of a physical property of an object or a part of an object occupying that coordinate.

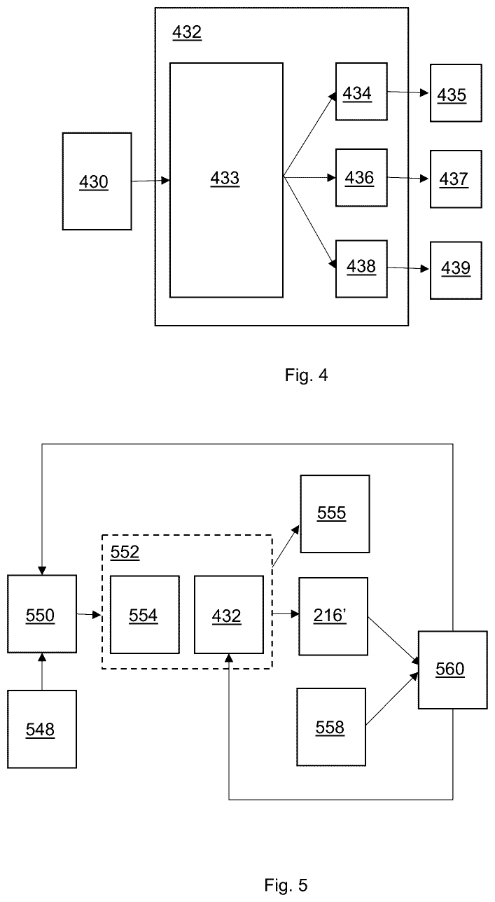

Referring to FIG. 4, there is illustrated an example of a scene representation model 432. In this example, the scene representation model 432 provides an implicit scene representation. Specifically, in this example, the scene representation model 432 comprises a multi-layer perceptron 433. A multi-layer perceptron may be a neural network having multiple, fully connected, layers. For example, the multi-layer perceptron 433 may be a 4-layer MLP, for example comprising four fully connected layers. The multi-layer perceptron 433 has a semantic head 438. For a coordinate 430 of the scene representation 202′ input to the multi-layer perceptron 433, the semantic head 438 outputs the prediction 439 of the value of the physical property at that coordinate. In this example, the multi-layer perceptron 433 further has a volume density head 436. For the coordinate 430 of the scene representation 202′ input into the multi-layer perceptron 433, the volume density head 436 outputs a prediction 437 of the volume density at that coordinate. In this example, the multi-layer perceptron further has a photometric head 434. For the coordinate 430 of the scene representation 202′ input into the multi-layer perceptron 433, the photometric head 434 outputs a prediction 435 of a photometric value, such as a radiance, at that coordinate. This may provide that the scene representation model 432 may predict physical properties (such as mass, stiffness, material type etc) as well as photometric values (e.g. radiance) and geometry (e.g. shape) in a resource efficient manner. The semantic head 438 and the volume density head 436 and/or the photometric head 434 sharing the same multi-layer perceptron 433 backbone may provide that an update to a prediction of a physical property value for a part of one scene representation (such as a part of an object) may be automatically propagated to other parts of the same geometrically (or photometrically) continuous region of the scene representation (such as other parts of the same object). This may improve the efficiency with which the scene representation model can be updated.

The scene representation model 432 may be trained to represent the scene 202. That is, the parameters of the scene representation model 432 may be optimised so that the scene representation model accurately predicts the geometry and appearance of the scene 202. This may be done, for example, by minimising a loss between obtained properties of the scene (such as physical, geometric and photometric properties) and predictions of those properties by the scene representation model 432. For example, this may comprise obtaining a labelled captured image of the scene (or sampled portions thereof) and a virtual image (or corresponding sampled portions thereof) rendered from the scene representation model 432, and optimising the scene representation model so as to minimise a loss between the captured image and the rendered image.

For example, the scene representation model 432 may be formulated as:

$${F}_{θ} ( p ) = ( c , s , ρ ) \qquad ( 1 )$$

where F_{θ} is the multi-layer perceptron 433 parameterised by θ; c, s, and ρ are the radiance, physical property, and volume density at the 3D position p=(x, y, z), respectively. A virtual image of the scene may comprise volumetric renderings of colour, physical property, and depth. For example, referring briefly again to FIG. 3, a virtual image 216′ may be constructed by, for each pixel [u, v] of the virtual image 216′, projecting a ray 218 from the virtual camera 210′, having a pose T, into the virtual space 202′. The radiance, physical property, and volume density values at each of a plurality of sample points 220 (indexed i) along the ray 218 may then be determined by inputting the 3D position p of those sample points into equation (1) (also referred to as querying the MLP). The volumetric rendering of colour Î, physical property Ŝ, and depth \hat{D} for pixel [u, v] may then be computed by compositing the radiance c, physical property s, and volume density values ρ of the sample points i along the back-projected ray 218 of pixel [u, v]according to:

$$\hat{I} [ u , v ] = {\sum }_{i = 1}^{N} {w}_{i} {c}_{i} , \hat{S} [ u , v ] = {\sum }_{i = 1}^{N} {w}_{i} {s}_{i} , \hat{D} [ u , v ] = {\sum }_{i = 1}^{N} {w}_{i} {d}_{i} , \qquad ( 2 )$$

where wᵢ=oᵢΠⱼ₌₁ⁱ⁻¹(1−oⱼ) is the ray termination probability of sample i at depth di along the ray; oᵢ=1−e^{-ρ}^{ᵢ}^{δ}^{ᵢ} is the occupancy activation function; and δᵢ=dᵢ₊₁−dᵢ is the inter-sample distance.

The geometry and appearance of the scene representation may then be optimised by minimising the discrepancy or a loss between the rendered depth image 216′ of the virtual scene 202′ and a captured depth image of the scene 202 (e.g. captured by camera 210). For example, this optimisation may be based on sparsely sampled pixels from the captured depth image, and a corresponding sample of pixels from the rendered depth image (e.g. the volumetric rendering may only be carried out for the sampled pixels). This may help reduce the resource burden, and hence increase the speed, of optimising the scene representation model. In some examples, this process may be conducted for a set of W captured depth images. For example, these W captured depth images may be keyframes from a video stream, for example selected as keyframes for including new information or new perspectives of the scene 202. However, it will be appreciated that in some examples, there may only be one captured image, that is, W may equal 1. Further, in some examples, this optimisation process may also include the optimisation of the pose T of the virtual camera 210′. However, it will be appreciated that in some examples the pose T of the virtual camera 210′ may be known or estimated or derived using different means, and may be taken as a given or fixed parameter in the optimisation process.

Minimising the loss between the captured and rendered image(s) may comprise minimising a photometric loss and a geometric loss for a selected number of rendered pixels sᵢ. For example, the photometric loss Lₚ may be taken as the L1-norm between the rendered colour value and the captured colour value eᵢ^{P}[u, v]=|Iᵢ[u, v]−Îᵢ[u, v]| for M pixel samples:

$${L}_{p} = \frac{1}{M} {\sum }_{i = 1}^{W} {\sum }_{( u , v ) ∈ {s}_{i}} {e}_{i}^{p} [ u , v ] . \qquad ( 3 )$$

Similarly, the geometric loss L_{g} may measure a difference between the rendered depth value and the captured depth value eᵢ^{g}[u, v]=|Dᵢ[u, v]−\hat{D}ᵢ[u, v]| and may use a depth variance along the ray \hat{D}ᵥₐᵣ[u, v]=Σᵢ₌₁^{N}wᵢ(\hat{D}[u, v]−dᵢ)² as a normalisation factor to down-weigh the loss in uncertain regions such as object borders:

$${L}_{g} = \frac{1}{M} {\sum }_{i = 1}^{W} {\sum }_{( u , v ) ∈ {s}_{i}} \frac{{e}_{i}^{g} [ u , v ]}{\sqrt{{\hat{D}}_{var} [ u , v ]}} . \qquad ( 4 )$$

An optimiser, such as an ADAM optimiser, may then be applied on a weighted sum of both losses, with a factor λₚ adjusting the importance given to the photometric loss:

$${min}_{θ , {T}_{i}} ( {L}_{g} + {λ}_{p} {L}_{p} ) . \qquad ( 5 )$$

Accordingly, the obtained scene representation model 432 may represent the scene 202. The scene representation model 432 is configured to predict a value s of a physical property of one or more of the objects. However, as yet, in the above described optimisation process, the scene representation model 432 has not necessarily yet been optimised with respect to physical property s. Accordingly, the predicted physical property may not be accurate. However, the accuracy of the physical property predictions can be improved by, as per steps 104 and 106 of the method of FIG. 1, obtaining a value of the physical property of at least one of the objects 204, the obtained value being derived from a physical contact of a robot 214 with the at least one object 204, and updating the scene representation model 432 based on the obtained value. Examples of deriving and obtaining the value of the physical property are described in more detail below. However, for continuity with the above optimisation example, an example of updating the scene representation model 432 based on the obtained value of the physical property of at least one of the objects 204 will now be described.

For example, a robot may physically contact an object 204 and from this derive a value of a physical property of the object 204. Apart of the captured depth image of the scene 202 showing the object 204 may be labelled with the obtained physical property value S. For example, one or more (hereinafter K) pixels of the captured depth image that correspond to a location in the scene 202 at which a physical property value of an object was measured may be labelled with the physical property value. As another example, K pixels of the captured depth image that correspond to a location of an object 204 for which the physical property value was obtained may be labelled with the physical property value S. As mentioned above, in the virtual image 216′, the volumetric rendering of physical property Ŝ for pixel [u, v] may be computed according equation (2). Minimising the loss between the captured and rendered image may comprise minimising a physical property loss Lₛ for the K pixels (ξᵢ) for which there is a physical property value label.

For example, in some cases, the physical property value may be continuous, that is, the physical property value may be one of a continuum of values. In these examples the physical property loss Lₛ may, for example, measure a mean-square error between the rendered physical property value and the captured physical property value eᵢ^{S}[u, v]=(Sᵢ[u, v]−Ŝᵢ[u, v])² for K pixels. As another example, in some cases, the physical property value may be a category or class from among a set of C classes. For example, where the physical property is mass, the value may be one of three classes: light, heavy, very heavy. In these examples, the volumetric rendering of physical property Ŝ may first be subjected to softmax activation Ŝ[u, v]=softmax(Ŝ[u, v]). The physical property loss Lₛ may, for example, measure a cross-entropy loss between the activated rendered physical property value and the d physical property value label, eᵢ^{S}[u, v]=−Σ_{c=1}^{C}Sᵢ^{C}[u, v]log Ŝᵢ^{C}[u, v] for K pixels. In either case, the physical property loss Lₛ may be given by:

$${L}_{s} = \frac{1}{K} {\sum }_{i = 1}^{W} {\sum }_{( u , v ) ∈ {ξ}_{i}} {e}_{i}^{s} [ u , v ] . \qquad ( 6 )$$

The scene representation model 432 may then be updated/optimised by minimising the physical property loss (with respect to the parameters of the scene representation model). In some examples, the scene representation model 432 may be updated by minimising the physical property loss only. In some examples, the scene representation model 432 may be optimised so as to jointly minimise the physical property loss and one or both of the geometric loss and the photometric loss, for the K pixels (ξᵢ) for which there is a physical property value label. For example, the scene representation model 432 may be optimised by minimising the following objective function:

$${arg min}_{θ} \frac{1}{K} {\sum }_{i = 1}^{W} {\sum }_{( u , v ) ∈ {ξ}_{i}} {e}_{i}^{g} [ u , v ] + {α}_{p} {e}_{i}^{p} [ u , v ] + {α}_{s} {e}_{i}^{s} [ u , v ] , \qquad ( 7 )$$

where αₚ is a factor adjusting the importance given to the photometric loss, and αₛ is a factor adjusting for the importance given to the physical property loss. Accordingly, the scene representation model 432 is updated based on the obtained value, and as a result the scene representation model 432 may more accurately represent the physical properties of the objects 204 of the scene, and hence may more accurately represent the scene.

Referring to FIG. 5, there is illustrated a flow between functional blocks according to an example. In some examples, one or more of the steps or functions performed by one or more of the functional blocks of FIG. 5 may form part of the method of FIG. 1.

Referring now to FIG. 5, in some examples, as illustrated, the flow starts with a pose estimation module 550 configured to estimate the pose T of the camera 210. In some examples, the pose of the camera 210 need not be estimated. For example, the pose of the camera 210 may be known, for example because the pose of the camera 210 is fixed or predetermined, or because it has been derived for example from a known configuration of the joints 215 of the robotic arm 206 on which the camera 210 is fixed. In these examples, the pose estimator 550 may simply take the pose as the known pose, or the known pose may be provided directly to the virtual image renderer 552 (described in more detail below) without use of the pose estimator 550. Nonetheless, in the illustrated example, the pose estimation module 550 estimates the pose T of the camera 210.

In some examples, as illustrated, the pose estimation module 550 may receive an initial estimate of the pose of the camera 210 from an initial estimator 548. For example, the initial estimator 548 may provide an initial estimate of the pose of the camera based at least in part on data indicative of a configuration of a device 206 used to position the camera 210. For example, the initial pose estimate may be derived based on the known configuration of the joints 215 of the robotic arm 206 on which the camera 210 is fixed. As mentioned, in some examples, the pose estimator 550 may be removed and the initial estimator 548 may provide the initial estimate of the pose of the camera 210 directly to the virtual image renderer 552. This may help allow for an efficient estimation of the camera pose. Use of the pose estimation module 550 may help allow for the camera pose to be estimated even where the camera pose it not necessarily known in advance, and hence improve flexibility. Alternatively or additionally, this may help the camera pose estimate to be fine-tuned from the initial estimate.

In any case, in these examples, the pose of the camera 210, or an estimate thereof, is provided to the virtual image renderer 552. The virtual image renderer 552 comprises a volumetric renderer 552 and the scene representation model 432. The volumetric renderer 552 may use the provided pose (or estimate thereof) of the camera 210 in real space 202 to determine a pose of the virtual camera 210′ in virtual space 202′. For example, this may be by suitable coordinate transformation from the real space 202 to the virtual space 202′. The virtual image renderer 552 renders a virtual image 216′ of the scene representation model 432 according to the determined pose of the virtual camera 210′. Similarly to as described above with reference to equations (1) and (2), one or more parts of the virtual image 216′ (e.g. the one or more selected pixels sᵢ or ξᵢ of the virtual image 216′) may each be labelled with a predicted depth value \hat{D}[u, v] indicative of a depth, of a portion of the scene representation that the part represents, from the virtual camera 210′ at which the virtual image 216′ is rendered. Further, one or more parts of the virtual image 216′ (e.g. the one or more selected pixels sᵢ or ξᵢ of the virtual image 216′) may each be labelled with a predicted photometric value Î[u, v] (e.g. colour) indicative of a predicted photometric property, of a portion of the scene representation that the part represents, at a virtual camera 210′ at which the virtual image is rendered. Further, one or more parts of the virtual image 216′ (e.g. the one or more selected pixels sᵢ or ξᵢ of the virtual image 216′) may be labelled with the respective predicted physical property value Ŝ[u, v] for the respective object that the respective part represents. Accordingly, a virtual image 216′ indicating the predicted depth, predicted photometric value (e.g. colour), and predicted physical property value of objects 204, 206 of the scene 202 is produced.

The virtual image 216′ is provided to an optimiser 560. Also provided to the optimiser 560 is a captured depth image 558 of the scene 202 captured by the camera 210. The camera 210 may be a depth camera, such as an RGB-D camera. The optimiser 560 is configured to optimise the scene representation model 432 so as to minimise a loss between the captured image 558 and the virtual image 216′. In examples, as illustrated, where the pose of the camera 210 is estimated by a pose estimation module 550, the optimiser may be configured to jointly optimise the scene representation model 432 and the pose estimation module 550, by minimising a loss between the captured image 558 and the virtual image 216′.

For example, one or more parts of the captured image 558 (e.g. the one or more selected pixels sᵢ or ξᵢ of the captured image 558) may each be labelled with an obtained depth value Dᵢ[u, v] indicative of a depth, of a portion of the scene 202 that the part represents, from the camera 210 that captured the image 558. Further, one or more parts of the captured image 558 (e.g. the one or more selected pixels sᵢ or ξᵢ of the captured image 558) may be labelled with an obtained photometric value (e.g. colour) Î[u, v]indicative of a photometric property, of a portion of the scene 202 that the part represents, at the camera that captured the image 558.

In examples where the physical property value Sᵢ[u, v]has not yet been obtained, the captured image 558 may not (yet) be labelled with an obtained physical property value derived from physical contact of the robot 208 with the object 204. In this case, in some examples, the captured image 558 may not (yet) be labelled with any physical property values. In this case the optimiser 562 may optimise the scene representation model 432 (and in some examples also the pose estimation module 550) based on the depth and photometric value labels of the captured image 558 (for example as described above with reference to equations (1) to (5)).

In some examples, the captured image 558 may be labelled with an estimate of the physical property value of an object of the scene shown in the captured image 558. For example, a pre-trained object detector (not shown) may be applied to the captured image 558 to identify at least one object 204, and the estimate of the physical property value may be inferred from the identity of the at least one object 204. For example, if the object 204 is identified as a chair, an estimate of the mass of the object 204 may be provided as an average mass of household chairs, for example. In these cases, one or more parts of the captured image 558 (e.g. the one or more selected pixels sᵢ or ξᵢ of the captured image 558) may each be labelled with an estimate of a physical property value of the object 204 that the part represents. In these cases, the optimiser 560 may optimise the scene representation model 432 (and in some examples also the pose estimation module 550) based on the estimated physical property value labels of the captured image 558, and in some examples also based on the depth and/or photometric value labels of the captured image 558 (e.g. similarly to as described above for equations (6) and (7)). As such, the scene representation model 432 been pre-trained by optimising the scene representation model 432 so as to minimise a loss between a provided estimate of a value of the physical property of at least one object 204 of the scene 202 and the predicted value of the physical property of the at least one object. This may help provide a relatively accurate scene representation relatively quickly, for example as compared to starting with no information about the physical property value of any of the portions of the scene.

In examples where the physical property value derived from physical contact of the robot 208 with the object 204 has been obtained (e.g. as described in more detail below), one or more parts of the captured image 558 (e.g. the one or more selected pixels ξᵢ of the captured image 558) may each be labelled with the obtained physical property value Sᵢ[u, v] of the object 204 that the part represents. In these cases, the optimiser 560 may optimise the scene representation model 432 (and in some examples also the pose estimation module 550) based on the obtained physical property value labels of the captured image 558, and in some examples also based on the depth and/or photometric value labels of the captured image 558 (e.g. as described above with reference to equations (6) and (7)).

As mentioned, step 104 of the method of FIG. 1 involves obtaining a value of the physical property of at least one of the objects 204, the obtained value being derived from a physical contact of a robot 208 with the at least one object 204.

In some examples, the method may comprise selecting the at least one object 204 from among a plurality 204,206 of the one or more objects 204, 206. For example, the method may comprise determining which of the objects 204, 206 of the scene 202 to control the robot 208 to physically contact, and hence which of the objects 204, 206 to obtain the value of the physical property. For example, the method may comprise controlling the robot 208 to physically contact the selected object 204; and deriving the value of the physical property of the selected object 204 from the physical contact, thereby to obtain the value.

In some examples, the selection may be based on an uncertainty of the predicted value of the physical property of each of the plurality of objects 204, 206. This may allow for the robot 208 to autonomously select the object 204 to physically contact that may result in the largest decrease in uncertainty in the scene representation model 432, and hence provide for the largest gain in accuracy and/or reliability of the scene representation model 432.

For example, when the virtual image 216′ is generated, an uncertainty of the predicted physical property value may be computed for each pixel of the virtual image 216′. For example, the uncertainty of the predicted value of the physical may be given by one or more of softmax entropy, least confidence, and marginal sampling. For example, where the predicted value is a predicted class or category from among C classes or categories, the softmax entropy may be defined as:

$${u}_{entropy} = - {\sum }_{c = 1}^{C} {\hat{S}}^{c} [ u , v ] log {\hat{S}}^{c} [ u , v ] ) . \qquad ( 8 )$$

This may be determined for each pixel of the virtual image 216′. As a result, an uncertainty map 555 may be generated. Each pixel value of the uncertainty map 555 indicates uncertainty of the physical property value prediction by the scene representation model 432 for the object 204 (or part thereof) shown in that pixel. The method may comprise selecting one or more of the pixels based on the uncertainty value. For example, the selection may be from among pixels that have an uncertainty value within the top X % of all of the uncertainty values of the map 555. For example, the selection may be from among a sample, for example a random sample, of pixels from the uncertainty map that have an uncertainty value within the top X % of all of the uncertainty values of the map 555. For example, X % may be 0.5%. For example, the selection may be of the pixel or pixels with the highest uncertainty values. In any case, the selected pixel or pixels may be projected into virtual space 202′ (e.g. using the pose of the virtual camera 210′) to determine a location in virtual space 202′ to which the pixel or pixels correspond. From this, the object 204′ or part of an object 204′ in virtual space 202′ located at this location may be determined. The object 204 that the robot is to physically contact may then be determined as the object 204 corresponding to the determined virtual object 204′. For example, the robot 208 may be controlled to physically contact the object 204 that corresponds to the determined virtual object 204′, and derive the value of the physical property of that object 204 from the physical contact, thereby to obtain the value. The obtained value may used to label the associated pixel of the captured image 558, for example as described above, and the scene representation model 432 may be updated/optimised, for example as described above. As a result, the uncertainty of the prediction of the physical property value of the object 204 by the scene representation model 432 may be reduced. Further, as a result, a new uncertainty map 555 may be produced which reflects the reduction in uncertainty for the object 204. In some examples, this process may be repeated until the uncertainty values of all the pixels of the uncertainty map 555 (or e.g. all of the pixels corresponding to locations that it is kinematically feasible for the robot 208 to interact with, see below) are below a certain threshold. For example, at this point, it may be determined that the scene representation model 202′ sufficiently accurately reflects the scene 202.

In some examples, the selection of the object 204 to contact is based on further criteria. For example, in some examples, selecting the at least one object 204 may comprise determining a kinematic cost and/or feasibility of the physical contact of the robot 208 with each of the plurality of objects 204, 206; and the at least one object 204 may selected based additionally on the determined kinematic feasibility for each of the plurality of objects 204, 206. For example, the kinematic feasibility may represent whether, or the extent to which, the robot 208 can move and/or configure itself so as to physically contact the object 204, 206 (or physically contact in a way that would allow the desired physical property value to be obtained). The kinematic cost may represent the cost (e.g. in terms of energy or time) of the robot 208 moving and/or configuring itself so as to contact the object 204, 206. For example, as mentioned, in some examples the selection of the pixel or pixels from the uncertainty map 555 may be from among a random sample of pixels from the uncertainty map that have an uncertainty value within the top 0.5% of all of the uncertainty values of the map 555. The method may comprise iterating through the random sample, from highest uncertainty value to lowest uncertainty value, checking each pixel for kinematic feasibility, until a feasible pixel is found. The object that the robot 208 is controlled to select may then be determined based on this feasible pixel, for example as described above. For example, a feasible pixel may be one corresponding to a location in 3D space that it would be feasible or possible for the robot 208 to reach, or physically contact, or physically contact in a way that would allow the desired physical property value to be obtained.

In some examples, the method may comprise: responsive to a determination that the physical contact of the robot 208 with a given one of the plurality of objects 204, 206 is not kinematically feasible, adding the given object 204, 208 to a selection mask to prevent the given object from being selected in a further selection of an object 204, 206 of which to obtain a value of the physical property. For example, as mentioned, the method may comprise iterating through the random sample of pixels from the uncertainty map 555, from highest uncertainty value to lowest uncertainty value, checking each pixel for kinematic feasibility, until a feasible pixel is found. Pixels that are determined during this process to be not kinematically feasible may be added to a mask applied to the uncertainty map 555, to prevent those pixels from being selected in a further pixel selection.

In some examples, updating the scene representation model 432 based on the obtained value need not necessarily involve comparing captured and virtual images of the scene, as per some of the examples described above. For example, in some examples, the scene representation model 432 may be optimised by minimising a loss between the obtained value and a value of the physical property predicted directly by the scene representation model 432.

For example, there may be determined a three-dimensional location (x, y, z) at or for which a physical property value is to be obtained. For example, this location may correspond to an object 204 for which the physical property is to be obtained. For example, the object 204 and/or location may be determined based on an entropy map 555 for example as described above. The robot 208 may accordingly physically contact the object 24 at that location and derive from that physical contact a physical property value of the object 204. For example, as described in more detail below, the robot 208 may place a spectrometer probe at that location. The spectrometer probe may output an N-dimensional vector indicative of a spectral signature of the material of the object 204 at that location. The measured physical property value (e.g. the N-dimensional vector) may be input into a pretrained classifier that has been trained to output a category or class for the physical property value among a set of classes C. For example, the N-dimensional vector output by the spectrometer may be input into the pretrained classifier which may output a material type class or category for the N-dimensional value/vector. The output category or class may be one-hot encoded amongst the other classes in the set of C classes (for example, the output class may be encoded as a vector having C elements, where the element corresponding to the output class is given the value 1, and all other elements are given the value 0). This may be taken as a ground truth for the class of the physical property of the object 204 at the 3D location, and may be used as the obtained value of the physical property of object 204.

In these examples, the predicted value of the physical property of the object may be provided by inputting the corresponding 3D location in virtual space (x′, y′, z′) into the scene representation model 432, and obtaining from the physical property head 438 a direct prediction of the physical property value at that location. The physical property head 438 may be configured to output the prediction of the physical property value as a predicted class or category among the set of classes C (e.g. material type). For example, similarly to the above example, the physical property head 428 may be configured to output the predicted class in the form of a one-hot encoding amongst the classes C (e.g. material types).

In these examples, the physical property loss may, for example, measure a cross-entropy loss between the predicted physical property value and the obtained physical property value. For example, the physical property loss may measure a cross entropy loss between the one-hot encoded predicted class output from the scene representation model 432 and the one-hot encoded ground truth class provided via the pretrained classifier. In this case, updating the scene representation model 432 may comprise optimising the scene representation model 432 (e.g. adjusting parameters thereof) so as to minimise this physical property loss. Other examples of updating the scene representation model 432 based on the obtained value may be used.

As mentioned, the obtained value (on the basis of which the scene representation model 432 is updated) is derived from a physical contact of a robot 208 with the at least one object 204. Accordingly, in some examples, and as mentioned above, the method may comprise controlling the robot 208 to physically contact the at least one object 204 and/or deriving the obtained value from the physical contact.

In some examples, the physical contact of the robot 208 with the at least one object 204 of the scene 202 may comprise a physical movement of, or an attempt to physically move, the at least one object 204 of the scene 202 by the robot 208, and the obtained value may be derived from the physical movement or the attempt. The robot 208 interacting with the scene 202 can physically move objects (or at least attempt to), and this does not necessarily require special measurement probes, which may, in turn allow for the physical property to be determined in a cost effective manner.

For example, the physical contact may comprise one or more of a top-down poke of the at least one object 204, a lateral push of the at least one object 204, and a lift of the at least one object 204.

For example, the value of the physical property may be indicative of one or more of a flexibility or stiffness of the at least one object 204, a coefficient of friction of the at least one object 204, and a mass of the at least one object 204. These properties may be determined by movement of the object (or an attempt to move the object) by the robot 208, and hence need not necessarily involve a special measurement probe to contact the object, which may be cost effective.

For example, in one example, the physical contact may comprise a top-down poke. For example, this may comprise poking or pushing a finger or other portion of the robotic arm 208 vertically downward onto the object 204. A force sensor may measure a force exerted by the robotic arm 208 onto the object 204. For example, the force sensor may be included on the tip of the finger or other portion of the robotic arm 208, that contacts the object 204. As another example, one or more force sensors (e.g. torque sensors) may be included into one or more of the joints 215 of the robotic arm, and the output of these sensors may be converted to a force applied to the object 204. The force exerted by the robotic arm 208 on the object 204 may be measured in conjunction with the distance of travel of the finger or other portion of the robotic arm while contacting the object 204. This may allow a stiffness of the object 204 or of a material of the object 204 to be approximated or determined. For example, stiffness may be defined as k=F/δ, where F is the top-down force applied to the object 204 and 6 is the displacement produced by the force in the direction of force (that is, the distance that the finger travels when contacting the object 204 when the force F is applied). Flexibility of an object 204 or a material of an object 204 may be approximated as an inverse of the stiffness. From the physical property of stiffness/flexibility, other physical properties may be derived, for example, the material type or property of the object (e.g. soft furnishing vs hard table or floor surface).

As another example, the physical contact may comprise a lateral push of the object 204. For example, this may comprise pushing a finger or other portion of the robotic arm laterally or horizontally against the object 204. Similarly to as above, one or more force sensors may measure a force exerted by the robotic arm 208 onto the object 204 during the lateral push. The force required in the lateral push in order to cause the object to move may be proportional to the coefficient of friction between the object 204 and surface on which the object 204 is placed and is also proportional to the normal force of the object 204 (which, for example, in the case of a flat horizontal floor is proportional to the mass of the object 204). Accordingly, if the mass of the object 204 is known or estimated then an estimate of the coefficient of friction may be obtained from the force of the lateral push. Conversely, if the coefficient of friction is known or estimated then an estimate of the mass of the object 214 may be obtained from the force of the lateral push. In any case, force of the lateral push required to move the object may be indicative of the physical property of the moveability of the object 204. For example, if a high lateral push force is required to move the object 204 then the moveability of the object may be determined to be low, whereas if a low lateral push force is required to move the object 204 then the moveability of the object may be determined to be high. Similarly, if a high lateral push force does not result in the movement of the object 204, then the object may be determined as non-moveable, for example in cases where objects are fixed to the floor. As another example, one or more audio sensors (such as a microphone) may measure a volume or intensity or other characteristic of a sound that occurs during the lateral push of the object 204. The measured characteristic of the sensed sound may be used as a proxy for a coefficient of friction of the object 204 and the surface and/or for example a measure of the extent to which the object 204 may scratch the surface when being moved. For example, high amplitude sounds may indicate a high coefficient of friction and/or a high degree of scratching may occur when laterally moving the object 204 across the surface on which it is supported. In some examples, the lateral push on an object may be conducted at or below the estimated centre of gravity of the object 204. This may help avoid toppling an object.

As another example, the physical contact may comprise a lift of the object 204. For example, in some examples the lift may be a minor lift, that is, applying a vertically upward force to the object 204 but without the object 204 losing contact with the ground or only to a minor degree. This may allow for a lift to be performed, for example without necessitating a stable grasp of the object 204 by the robot 206. For example, this may comprise using a finger or other portion of the robotic arm 208 to apply a force vertically upward onto the object 204. Similarly to as above, one or more force sensors may measure a force exerted by the robotic arm 208 onto the object 204 during the minor lift. The measured force may provide an estimate of the mass of the object 204 (or an estimate of a lower bound of the mass of the object 204). In some examples, a minor lift may be performed at multiple locations on the object and this may be used to derive an estimate of the centre of mass of the object. For example, that location at which the largest force was required to lift the object 204 may be used to derive the centre of mass of the object 204 or may be used as an approximation of the centre of mas of the object 204. In some examples, a centre of mass of the object may be estimated using a lift, and this estimate of the centre of mass may be used to determine where to perform a lateral push on the object 204, as described above. In some examples, the physical contact may comprise grasping or grabbing the object 204 and performing the lift. For example, with a stable grasp or grab, a force required to vertically lift the object 204 may provide an estimate or the mass of the object 204. In each case of a poke, a push or a lift, a distance moved by the robot once contact has occurred may be relatively short, for example on the scale of a few millimetres, which is sufficient to sample the object's physical attributes but not sufficient to damage or change the location of objects materially in the scene, for example. Other physical contacts and derived physical properties are possible.

Updating the scene representation model 432 based on a mass or an estimate of the mass of an object 204 may be useful assisting the robot 208 to carry out tasks. For example, a task may be defined to tidy up empty cups. However, a cup that is full of water may look identical to an empty cup. But a full cup will have a greater mass than an empty cup. Accordingly, the robot 208 may physically contact a cup (such as by performing a lift or a minor lateral push) to derive an estimate of the mass of the cup, and update the scene representation model 432 based on the derived mass of the cup. The robot may then perform the defined task based on the updated scene representation model 432. For example, if the mass of the cup is low, the robot 208 may infer that the cup is empty and hence tidy up the cup, but if the mass is high the then the robot 208 may infer the cup is full and hence not tidy up the cup. As another example, similarly, a task may be defined to sort boxes which are identical in appearance, but which have different masses, by mass. Accordingly, the robot may perform a lateral push or a lift on each box to determine an estimate of the mass, update the scene representation model 432 based on the masses, and carry out the task based on the updated scene representation model 432.

In some examples, the physical contact of the robot with the at least one object 204 may comprise physical contact of a measurement probe 212 of the robot 208 with the at least one object 204, and the obtained value may be derived based on an output of the measurement probe when contacting the at least one object 204.

For example, the measurement probe 212 may comprise a single pixel multiband spectrometer. This may allow a dense spectroscopic rendering of an object 204 (or objects constituting the scene 202). For example, the single pixel multiband spectrometer may measure a spectral fingerprint of the object 204. In some examples, this spectral fingerprint may be compared to spectral fingerprints of known materials in a database. Accordingly, by matching the obtained spectral fingerprint of the object 204 with a spectral fingerprint of a known material or material type, the material or material type of the object 204 may be determined or estimated. In some examples, as described above, the output of the spectrometer may be an N-dimensional vector (where N>1), for example indicative of the spectral fingerprint of the object 204. This N-dimensional vector may be input to a pre-trained classifier (e.g. implemented by trained a neural network or other machine learning model) which maps the N-dimensional input vector onto a material or material type. Accordingly, the material or material type of the object 204 may be determined or at least estimated. Other measurements by the measurement devices may be used, and for example may be combined to improve the accuracy or reliability of the determination of a material or material type of the object 204. For example, a thermal conductivity sensor may measure the thermal conductivity of the object 204 (or a material thereof). As another example, a porosity sensor may measure the porosity of the material. Form any one or more of the derived physical properties, a material or material type of the object may be determined or estimated. This may be useful for tasks such as sorting rubbish objects 204 into recyclable material objects and non-recyclable material objects, and for example, within the recyclable material objects, the type of recyclable material that the object contains. As another example, this may be useful for tasks such as laundry objects into woollen objects and synthetic objects.

In some examples, the scene representation model 432 may be configured to predict values for each of multiple physical properties of objects 204, 208 of the scene. For example, the physical property head 438 may be configured to output multiple values corresponding to multiple physical properties. Accordingly, multiple values of multiple physical properties of one or more objects 204 of the scene may be derived from a physical contact of the one or more objects 204 by a robot 208, and the scene representation model 432 may be updated based on the these multiple values. This may allow for a yet more complete and/or accurate representation of the scene 202 to be provided.

As mentioned, in some examples, the method may comprise controlling the robot 208 (or another robotic device, not shown) to carry out a task based on the updated scene representation model 432.

In some examples, unwanted collisions of the robot 208 with the scene 202 may be avoided using a collision mesh constructed from a depth rendering of the scene representation model 432.

As mentioned above, in some examples, the optimisation process may be conducted for a set of W captured depth images (where W≥1). For example, these W captured depth images may be keyframes from a video stream, for example selected as keyframes for including new information or new perspectives of the scene 202. As mentioned, in some examples, there may only be one captured image, that is, W may equal 1. In some examples, physical contact of the robot 208 with the scene 202 may cause the position of one or more of the objects 204, 206 to change, and hence optimisation based on past keyframes may no longer be accurate. However, in such examples, the optimisation may be conducted based only on the latest keyframe. In this way, as objects move the scene representation model 432 may be updated accordingly. Moreover, this may allow for the robot to perform continuous exploration tasks, such as when objects are removed from the scene 202. For example, if the robot 208 was tasked with dismantling a pile of unknown objects, then as each object is removed from the pile and from the scene, the scene representation model 432 may be updated based on a new captured image, so as to continue with the task.

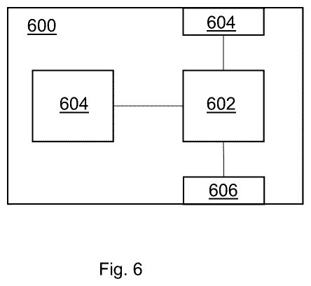

Referring to FIG. 6, there is illustrated an apparatus 600 according to an example. The apparatus 600 may be configured to perform the method according to any one of the examples described above with reference to FIGS. 1 to 5. In some examples, the apparatus 600 may be or may be part of a robot, such as the robot 208 according to any one of the examples described above with reference to FIGS. 1 to 5. In some examples, the apparatus 600 may comprise a computer configured to perform the method according to any one of the examples described above with reference to FIGS. 1 to 5. For example, the computer may be a remote server, for example a server that is remote from the robot 208, but for example communicatively connected to the robot 208 by wired or wireless means. In the illustrated examples, the apparatus 600 comprises a processor 602, a memory 604, an input interface 604 and an output interface 606. The input interface 604 may be configured, for example, to obtain the scene representation model 432 (which may be stored in memory 604) and/or to obtain the value of the physical property of the at least one object, for example. The output interface 606 may be used, for example, to output control instructions to cause the robot 208 to physically contact the at least one object 204 and/or to cause the robot 208 to perform a tasks based on the updated scene representation model 438, for example. The memory 604 may store a computer program comprising a set of instructions which, when executed by the processor 602, cause the processor 602 to perform the method according to any one of the examples described above with reference to FIGS. 1 to 5. In some examples, the computer program may be stored on a non-transitory computer readable medium. In some examples, there may be provided a non-transitory computer readable medium having instructions stored thereon which, when executed by a computer, cause the computer to perform the method according to any one of the examples described above with reference to FIGS. 1 to 5.

The above examples are to be understood as illustrative examples. It is to be understood that any feature described in relation to any one example may be used alone, or in combination with other features described, and may also be used in combination with one or more features of any other of the examples, or any combination of any other of the examples. Furthermore, equivalents and modifications not described above may also be employed within the scope of the accompanying claims.

1. A computer implemented method for updating a scene representation model, the method comprising:
obtaining a scene representation model representing a scene having one or more objects, the scene representation model being configured to predict a value of a physical property of one or more of the objects;
obtaining a value of the physical property of at least one of the objects, the obtained value being derived from a physical contact of a robot with the at least one object; and
updating the scene representation model based on the obtained value.

2. The method according to claim 1, wherein the physical contact of the robot with the at least one object of the scene comprises a physical movement of, or an attempt to physically move, the at least one object of the scene by the robot, wherein the obtained value is derived from the physical movement or the attempt.

3. The method according to claim 1, wherein the physical contact comprises one or more of a top-down poke of the at least one object, a lateral push of the at least one object, and a lift of the at least one object.

4. The method according to claim 1, wherein the value of the physical property is indicative of one or more of a flexibility or stiffness of the at least one object, a coefficient of friction of the at least one object, and a mass of the at least one object.

5. The method according to claim 1, wherein the physical contact of the robot with the at least one object comprises physical contact of a measurement probe of the robot with the at least one object, wherein the obtained value is derived based on an output of the measurement probe when contacting the at least one object.

6. The method according to claim 1, wherein the method comprises:
selecting the at least one object from among a plurality of the one or more objects based on an uncertainty of the predicted value of the physical property of each of the plurality of objects;
controlling the robot to physically contact the selected object; and
deriving the value of the physical property of the selected object from the physical contact, thereby to obtain the value.

7. The method according to claim 6, wherein selecting the at least one object comprises:
determining a kinematic cost and/or feasibility of the physical contact of the robot with each of the plurality of objects; and
wherein the at least one object is selected based additionally on the determined kinematic feasibility for each of the plurality of objects.

8. The method according to claim 7, wherein the method comprises:
responsive to a determination that the physical contact of the robot with a given one of the plurality of objects is not kinematically feasible, adding the given object to a selection mask to prevent the given object from being selected in a further selection of a object of which to obtain a value of the physical property.

9. The method according to claim 1, wherein the scene representation model provides an implicit scene representation of the scene.

10. The method according to claim 1, wherein updating the scene representation model comprises:
optimising the scene representation model so as to minimise a loss between the obtained value and the predicted value of the physical property of the at least one object.

11. The method according to claim 1, wherein updating the scene representation comprises:
labelling a part of a captured image of the scene with the obtained value for the object that the part represents;
obtaining a virtual image of the scene rendered from the scene representation model, one or more parts of the virtual image being labelled with the respective predicted value for the respective object that the respective part represents;
determining a loss between the obtained value of the labelled part of the captured image and the predicted value of a corresponding part of the virtual image; and
optimising the scene representation model so as to minimise the loss.

12. The method according to claim 11, wherein:
one or more parts of the captured image are each labelled with an obtained depth value indicative of a depth, of a portion of the scene that the part represents, from a camera that captured the image;
one or more parts of the virtual image are each labelled with a predicted depth value indicative of a depth, of a portion of the scene representation that the part represents, from a virtual camera at which the virtual image is rendered; and
wherein updating the scene representation model comprises:
determining a geometric loss between the obtained depth value of the one or more parts of the captured image and the predicted depth value of one or more corresponding parts of the virtual image; and
optimising the scene representation model so as to minimise the geometric loss.

13. The method according to claim 11, wherein the method comprises:
estimating a pose of a camera that captured the image when the captured image was captured; and
wherein the virtual image is rendered at a virtual camera having the estimated pose.

14. The method according to claim 13, wherein the pose of the camera is estimated based at least in part on data indicative of a configuration of a device used to position the camera.

15. The method according to claim 13, wherein the pose of the camera is estimated based at least in part on an output of a pose estimation module configured to estimate the pose of the camera, wherein optimising the scene representation model comprises jointly optimising the pose estimation module and scene representation model to minimise the loss.

16. The method according to claim 1, wherein the obtained scene representation model has been pre-trained by optimising the scene representation model so as to minimise a loss between a provided estimate of a value of the physical property of at least one object of the scene and the predicted value of the physical property of the at least one object.

17. The method according to claim 16, wherein the estimate is provided by applying a pre-trained object detector to a captured image to identify the at least one object, and inferring the estimate from the identity of the at least one object.

18. The method according to claim 1, wherein the method comprises:
controlling the robot to carry out a task based on the updated scene representation model.

19. An apparatus comprising: a processor; and a memory storing a computer program comprising a set of instructions which, when executed by the processor, cause the processor to perform the method according to claim 1.

20. A non-transitory computer readable medium having instructions stored thereon which, when executed by a computer, cause the computer to perform the method according to claim 1.
